(19) United States
(12) Patent Application Publication
(10) Pub. No.: US 2011/0080587 A1
(43) Pub. Date: Apr. 7, 2011

(54) Method and Apparatus for the Stabilization of Spectrometric Transducers

(76) Inventors: Roman Z. MORAWSKI, Poland (PL); Andrzej BARWICZ, Trois-Rivieres (CA); Tomasz OLESZCZAK, Trois-Rivieres (CA)

(21) Appl. No.: 12/901,238

(22) Filed: Oct. 8, 2010

Related U.S. Application Data
(63) Continuation of application No. 12/318,040, filed on Dec. 19, 2008, now abandoned.
Application No. 12/318,040 is a continuation of application No. 11/754,781, filed on May 29, 2007, now abandoned.
Application No. 11/754,781 is a continuation of application No. 11/038,490, filed on Jan. 21, 2005, now abandoned.
(60) Provisional application No. 60/537,919, filed on Jan. 22, 2004.

(51) Int. Cl. G01N 21/25

(52) U.S. Cl. 356/416

(57) ABSTRACT

The invention provides a method for stabilising a spectrometric transducer for an optical spectrum measuring instrument by obtaining an instantaneous central wavelength of a thermally controlled tunable filter of the instrument, calibrating for a selected ambient temperature, determining a heat variance of the filter and controlling the filter to compensate for heat variance.

This application is a continuation of U.S. patent application Ser. No. 12/318,040 filed on Dec. 19, 2008 which is a continuation of U.S. patent application Ser. No. 11/754,781 filed on May 29, 2007 which is a continuation of U.S. patent application Ser. No. 11/038,490 filed on Jan. 21, 2005 which claims priority from U.S. Provisional Patent Application No. 60/537,919 filed on Jan. 22, 2004.

### FIELD OF THE INVENTION

The present invention relates to a method for the stabilization of spectrometric transducers.

### BRIEF DESCRIPTION OF THE DRAWINGS

An embodiment of the present invention will now be described by way of example only with reference to the accompanying drawings, in which:

FIG. 1 is a schematic diagram of an optical spectrum measurement instrument.

FIG. 2 is a schematic representation of a portion of the apparatus shown in FIG. 1.

FIG. 3 is a flow diagram of a thermal stabilization method for a spectrometric transducer.

FIG. 4 is a plot showing the variation of controlling current for a particular set of parameters.

### DETAILED DESCRIPTION OF THE INVENTION

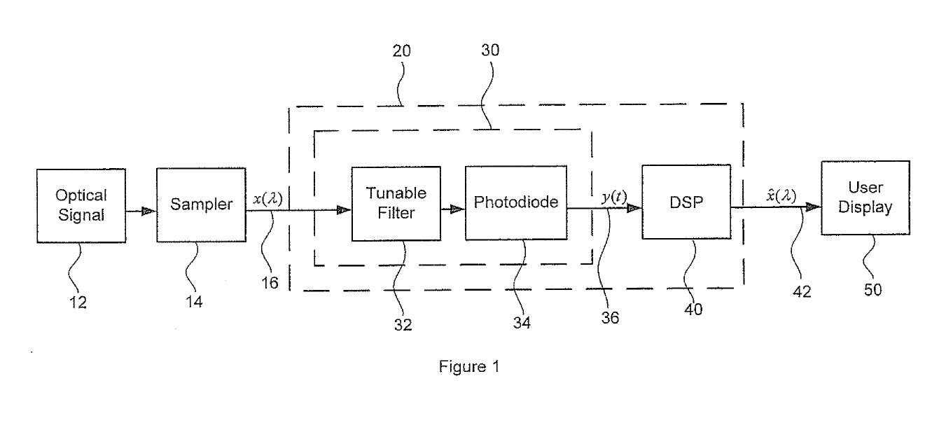

In FIG. 1 there is shown an optical spectrum measurement instrument 20 for analyzing optical signal 12. The optical signal 12 is sampled by sampler 14, which provides optical spectrum **16 to the optical spectrum measurement instrument 20. The optical spectrum measurement instrument 20 includes spectrometric transducer 30, including a tunable filter 32 and photodiode 34, and Digital Signal Processor (DSP) 40. Optical spectrum χ(λ) 16 is separated into its optical components by tunable filter 32, after which its components are converted from optical to current by photodiodes 34, resulting in an electrical spectrometric data representation y(t) 36 of optical spectrum χ(λ) 16. The spectrometric data representation y(t) 36 is then used by the DSP 40 to compute an estimate χ(λ) 42 of the optical signal 12 optical spectrum, which is then provided to user display 50. Optionally, the DSP 40 may also compute various parameters relating to the optical signal 12 optical spectrum such as power measurements, OSNR, BER, etc. or may implement signal analysis or reconstruction algorithms. The response of a filter to an input optical signal whose spectrum is χ(λ) 16, i.e. the output current of the photodiode 34, may be modelled by an integral operator of the form:

$$y ( t ) = {F}_{y} [ {\int }_{- ∞}^{+ ∞} g ( λ , t ) \cdot x ( λ ) \cdot d λ ] \qquad Equation 1$$

where λ is wavelength, t is time, g(λ, t) is the filter response function, and F_{y}[·] is a slightly nonlinear scalar function of a scalar variable. For a monochromatic input signal, whose spectrum is χ(λ)=δ(λ−1), this model responds with:

$$y ( t ) = {F}_{y} [ {\int }_{- ∞}^{+ ∞} g ( λ , t ) \cdot δ ( λ - l ) \cdot d λ ] = {F}_{y} [ g ( l , t ) ] \qquad Equation 2$$

and to the input signal whose spectrum is flat, χ(λ)=1, it responds with:

$$y ( t ) = {F}_{y} [ {\int }_{- ∞}^{+ ∞} g ( λ , t ) \cdot d λ ] ≡ {F}_{y} [ {g}_{0} ( t ) ] . \qquad Equation 3$$

The response g(1, t), defined by Equation 2, is a gaussoid-like function with a maximum changing monotonically with the wavelength 1. The function of time g₀(t), defined by Equation 3, characterizes the amplitude variability of the filter response along the wavelength axis.

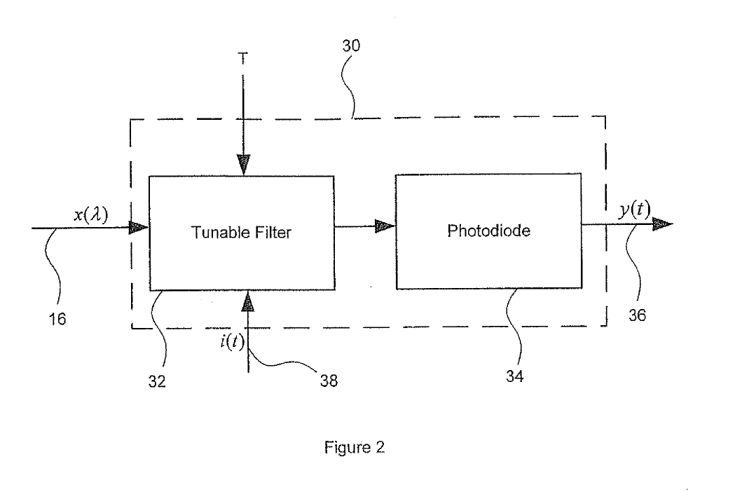

As shown in FIG. 2, the instantaneous central wavelength of the filter is externally controlled by the current i(t) 38. In the preferred embodiment, the filter 32 is a thermally controlled filter in which the central wavelength depends on its internal temperature. The current i(t) 38 drives a variable resistance heater incorporated in the filter. Such filters utilize the characteristic that as the temperature on tunable filters varies, such as a particular optical material's change in its index of refraction n with temperature T, so its center wavelength varies, resulting in thermally-controlled tunable filters. The temperature of the filter depends on the heat supplied from the resistence heater and the heat loss/gain to/from the ambient environment. To compensate for the heat loss/gain, a signal containing information about the ambient temperature is used to compensate the current i(t) 38 supplied to the heater. The current is adjusted by the controller that implements a control algorithm to maintain the filter at the desired center frequency.

Assume that the function λ=F₀ (u) is the result of wavelength calibration for a selected ambient temperature T₀ represented by the voltage U₀. Assume, moreover, that the input signal is generated by a battery of lasers whose central wavelengths are uniformly distributed in the interval [λₘᵢₙ, λₘₐₓ]:

$${λ}_{j} = {λ}_{min} + \frac{( j - 1 )}{J - 1} ( {λ}_{max} - {λ}_{min} ) \\ for j = 1 , … , J . \qquad Equation 4$$

Then, the maxima y_{0,j}^{max} of the response of the stabilized filter to such a signal may be easily identified together with the corresponding values of the voltage u(t):u_{0,j}=F₀⁻¹(λⱼ) for j=1, . . . , J. The practical purpose of controlling the current i(t) 38 may be now formulated as follows. For an arbitrary ambient temperature T, find i(t) such that the maxima of the stabilized filter response remain as close as possible to the maxima determined for T₀ , i.e. the coordinates of the maxima for the ambient temperature T, the values u₁, . . . , u_{J} of the voltage u(t) and the values y₁^{max}, . . . , y_{J}^{max} of the output signal y(t), satisfy the condition:

w[(u₁−u_{0,1})²+ . . . , +(u_{J}−u_{0,J})²]+(1−w)[(y₁^{max}−y_{0,1}^{max})²+ . . . +(y_{J}^{max}−y_{0,J}^{max})²]→MIN Equation 5

where w∈[0, 1] is a weighing factor.

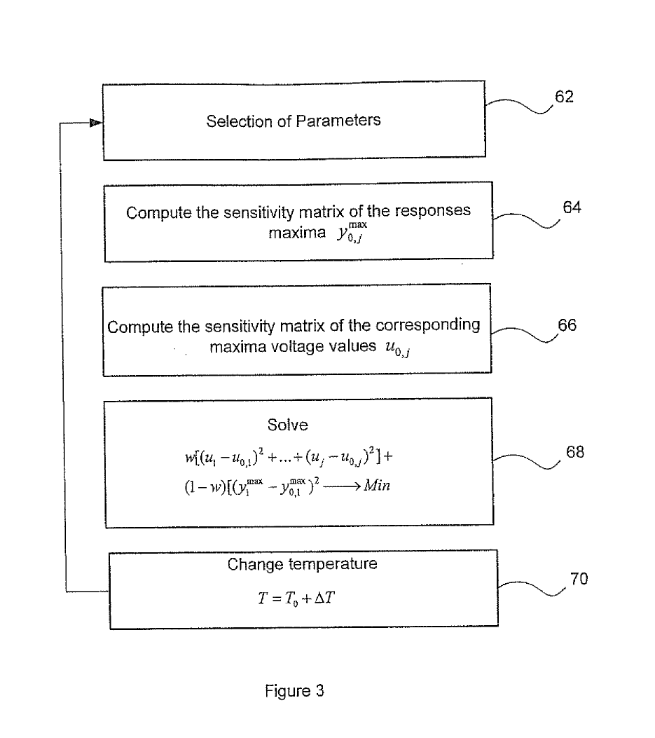

The task of control may be significantly simplified (at the price of the sub-optimality of the solution) by an appropriate parameterization of the heating current i(t). An example of such a parameterization is defined by the formula:

$$i ( t ) = \{ \begin{matrix}0 & for t < 0 \\ {i}_{1} & for t ∈ [ 0 , {t}_{2} ] \\ \frac{{i}_{3} - {i}_{2}}{{t}_{3} - {t}_{2}} ( t - {t}_{2} ) + {i}_{2} & for t ∈ [ {t}_{2} , {t}_{3} ]\end{matrix} \qquad Equation 6$$

where i₁, i₂, i₃, t₂ and t₃ are parameters of the current to be optimized by minimization of the left-hand side of Equation 5. The parameterization of controlled current enables one to use an empirical procedure of optimization that does not require any explicit reference to the mathematical model of the stabilized filter. This procedure is implemented in the controller and is depicted by the flow chart shown in FIG. 3. The sequence of steps composing the procedure is indicated by the sequence of blocks 62 to 70.

In block 62, for the selected ambient temperature T₀, the values of i₁, i₂, i₃, t₂ and t₃ are chosen so as to produce a relatively uniform distribution of u_{0,j}=F₀⁻¹(λⱼ) for j=1, . . . , J.

Then in block 64, on the basis of measurements performed for the same ambient temperature, the matrix S_{y}, of the sensitivity of the maxima y₁^{max}, . . . , y_{J}^{max} is computed for a small change in the ambient temperature ΔT and for small changes Δi₁, Δi₂, Δi₃, Δt₂ and Δt₃ in the parameters i₁, i₂, i₃, t₂ and t₃.

Similarly, in block 66, on the basis of measurements performed for the same ambient temperature, the matrix Sᵤ of the sensitivity of the corresponding maxima voltage values u₁, . . . , u_{J} to is computed for a small change in the ambient temperature ΔT and for small changes Δi₁, Δi₂, Δi₃, Δt₂ and Δt₃ in the parameters i₁, i₂, i₃, t₂ and t₃ .

In block 68, the following minimization problem is solved:

$$w {‖ {S}_{u} [ \begin{matrix}Δ T \\ Δ {i}_{1} \\ Δ {i}_{2} \\ Δ {i}_{3} \\ Δ {t}_{2} \\ Δ {t}_{3}\end{matrix} ] ‖}^{2} + ( 1 - w ) {‖ {S}_{y} [ \begin{matrix}Δ T \\ Δ {i}_{1} \\ Δ {i}_{2} \\ Δ {i}_{3} \\ Δ {t}_{2} \\ Δ {t}_{3}\end{matrix} ] ‖}^{2} \to MIN \qquad Equation 7$$

with respect to Δi₁, Δi₂, Δi₃, Δt₂ and Δt₃ for an assumed (sufficiently small) increment ΔT of the ambient temperature.

Following which, in block 70, the ambient temperature is changed to the value T=T₀+ΔT; the new values of i₁, i₂, i₃, t₂ and t₃ are computed using increments Δi₁, Δi₂, Δi₃, Δt₂ and Δt₃ determined in block 68; i₁, i₂, i₃, t₂ and t₃ are empirically corrected in such away as to satisfy the condition defined by Equation 5.

Finally, blocks 62 to 70 are repeated iteratively as to cover the whole range of ambient temperatures the stabilized filter is assumed to operate in.

It should be noted that the whole process of optimization is subject to the constraint concerning the admissible values of current and heating time.

A further refinement of the thermal stabilization of the stabilized filter is possible during the software pre-processing of the data provided by the stabilized filter using the above described hardware means. The residual instabilities may be characterized during general calibration of the stabilized filter, and the results of this characterization may next be used for correction of the raw data before their pre-processing.

A closer empirical study of the current i(t) control based on Equation 6 provides the following:
t₂ and t₃ may be fixed to the values 1 ms and 5 ms, respectively;
abrupt changes of current i(t) should be avoided;
a convex control in the interval [t₂, t₃] would be desirable.

Consequently, a second example of the current i(t) parameterization may been designed. It is defined by the formula:

$$i ( t ) = \{ \begin{matrix}0 & for t < 0 \\ {a}_{1} {t}^{2} + {b}_{1} t + {c}_{1} & for t ∈ [ 0 , 1 ] \\ {{a}_{2} ( t - 1 )}^{2} + {b}_{2} ( t - 1 ) + {c}_{2} & for t ∈ [ 1 , 5 ]\end{matrix} \qquad Equation 8$$

where the parameters a₁, b₁, c₁ and a₂, b₂, c₂ should satisfy the following conditions:

i(0)=I₀, i(1)=I₁, i(3)=I₃, and i(5)=I₅ Equation 9

The solution of the above algebraic problem has the form:

$$[ \begin{matrix}{a}_{1} \\ {b}_{1} \\ {a}_{2} \\ {b}_{2}\end{matrix} ] = [ \begin{matrix}1.000 & - 1.750 & 1.000 & - 0.250 \\ - 2.000 & 2.750 & - 1.000 & 0.250 \\ 0.000 & 0.125 & - 0.250 & 0.125 \\ 0.000 & - 0.750 & 1.000 & - 0.250\end{matrix} ] \cdot [ \begin{matrix}{I}_{0} \\ {I}_{1} \\ {I}_{3} \\ {I}_{5}\end{matrix} ] \qquad Equation 10$$

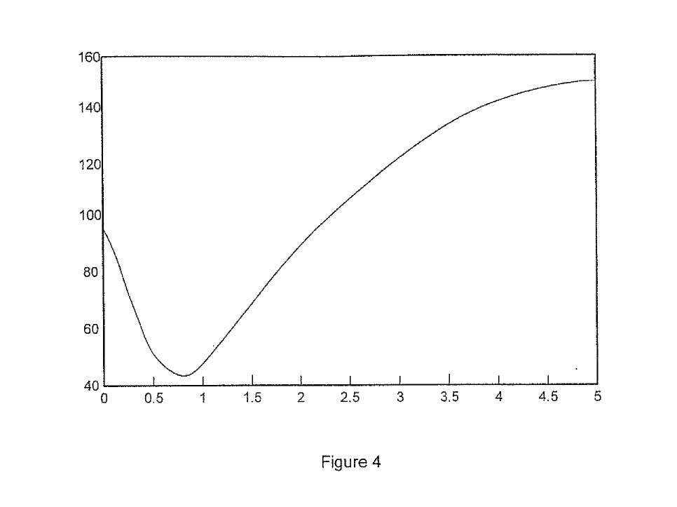

and c₁=I₀, c₂=I₁. An example of the current i(t) generated according to the above formula is shown in FIG. 4 and I₀=100 mA, I₁=50 mA, I₃=120 mA, and I₅−150 mA.

The components of a spectrometer or the device in which it is used such as an OPM are subject to aging. Consequently, the parameters of the OPM drift in time. In particular, the absolute accuracy of wavelength estimation is deteriorating. Taking into account that the contemporary DWDM transmitters contain highly stable lasers, one may use the time series of wavelength estimates as the basis for compensation of the time drift of the OPM.

The idea of using time series of wavelength estimates provided by the OPM for time drift compensation of this OPM is based on an assumption that the average deviation of the central wavelength of the laser signal used for this purpose is close to zero, i.e. there is no systematic evolution of this wavelength over time. Consequently, the average deviation of the central wavelength as computed by the OPM should be expected to also be close to zero. If not, this average deviation may be used to model the OPM's drift and provide a way of stabilizing the OPM by compensating for this time drift.

A wavelength such as described above may be modelled by means of a stochastic process:

l(t)=i+δl(t) Equation 11

where t is time, i is the central wavelength value according to the ITU grid, and δl(t) is a stochastic process modelling the wavelength deviation from the ITU-grid value. The latter process is assumed to be zero-mean and stationary. Consequently, the time sampling of l(t) at equidistant time points, t₁, . . . , t_{N}, yields the vector of random variables:

1=[l(t₁) . . . l(t_{N})]^{T} Equation 12

such that:

$$E [ \underline{l} ] = {[ i … i ]}^{T} \\ and \\ Cov [ \underline{l} ] = [ \begin{matrix}{σ}^{2} & … & {c}_{1 , N} \\ ⋮ & ⋱ & ⋮ \\ {c}_{N , 1} & … & {σ}^{2}\end{matrix} ] \qquad Equation 13$$

Under the above assumptions, a result of central wavelength measurement, provided by the OPM drifting in time, may be modelled with:

i(tₙ)=l(tₙ)+Δl(tₙ)=i+Δl(tₙ)+δl(tₙ) for n=1, . . . , N Equation 14

where Δl(tₙ) is the time drift of wavelength to be estimated on the basis of the realizations \hat{l}(tₙ) of the random variables \hat{l}(tₙ). The vector \hat{l}=└\hat{l}(t₁) . . . \hat{l}(t_{N})┘^{T} has the following statistical properties:

$$E [ \underline{\hat{l}} ] = {[ i + Δ {l}^{̑} ( {t}_{1} ) … \dot{l} + Δ {l}^{̑} ( {t}_{N} ) ]}^{T} \\ and \\ Cov [ \underline{{l}^{̑}} ] = {[ \begin{matrix}{σ}^{2} & … & {c}_{1 , N} \\ ⋮ & ⋱ & ⋮ \\ {c}_{N , 1} & … & {σ}^{2}\end{matrix} ]}^{T} ≡ Σ \qquad Equation 15$$

Assuming that the solution is to be approximated by a linear combination:

$$Δ l ( t ) = {\sum }_{j = 1}^{J} {p}_{j} {ϕ}_{j} ( t ) \qquad Equation 16$$

of known functions δⱼ(t), such as, for example, a polynomial, an orthogonal polynomial, a trigonometric polynomial, a b-spline, etc, with unknown coefficients pⱼ forming the vector p=[pᵢ . . . p_{J}]^{T}. This vector is to be estimated on the basis of the approximate equations:

$${\sum }_{j = 1}^{J} {p}_{j} {ϕ}_{j} ( {t}_{n} ) ≡ \hat{l} ( {t}_{n} ) - \dot{l} \\ for \\ n = 1 , … , N \qquad Equation 17$$

that may be given a matrix form:

Φp≅Δl Equation 18

where:

$$Φ = [ \begin{matrix}{ϕ}_{1} ( {t}_{1} ) & … & {ϕ}_{J} ( {t}_{1} ) \\ ⋮ & ⋱ & ⋮ \\ {ϕ}_{1} ( {t}_{N} ) & … & {ϕ}_{J} ( {t}_{N} )\end{matrix} ] \\ and \\ Δ \hat{l} = [ \begin{matrix}{l}^{̑} ( {t}_{1} ) - \dot{l} \\ ⋮ \\ {l}^{̑} ( {t}_{N} ) - \dot{l}\end{matrix} ] . \qquad Equation 19$$

Under an assumption that there is no correlation between consecutive samples provided by the OPM, i.e. all c_{n,v}=0, the LS solution of this equation has the form:

\hat{p}=(Φ^{T}Φ)⁻¹Φ^{T} Δ\hat{l} Equation 20

and the corresponding covariance matrix is:

Cov[\hat{p}]=(Φ^{T} Φ)⁻¹ σ² Equation 21

If the correlation between samples cannot be neglected, then the solution takes on the form:

\hat{p}=(Φ^{T} Σ⁻¹ Φ)⁻¹ Φ^{T} Σ⁻¹ Δ\hat{l}̂ Equation 22

and the corresponding covariance matrix is:

Cov[\hat{p}]=(Φ^{T} Σ⁻¹ Φ)⁻¹ Equation 23

If the samples may be considered uncorrelated, then estimates \hat{p}ⱼ, . . . , \hat{p}_{K} of the parameters p_{J}, . . . , p_{K}, characterizing the drift of K DWDM channels, may be obtained using the LS method, described in the previous section, in an integrated numerical process:

[\hat{p}ₗ . . . \hat{p}_{K}]=(Φ^{T} Φ)⁻¹ Φ^{T} [Δ\hat{l}₁. . . Δ\hat{l}_{K}] Equation 24

where Δ\hat{l}_{K} is the vector of deviations of the results of measurements of the central wavelength in the kth channel from the ITU-grid value of this wavelength. In general, the channels may differ in the laser wavelength deviation; the corresponding variances σ₁², . . . σ_{K}² may be estimated according to the formula:

$${\hat{σ}}_{k}^{2} = \frac{1}{N - J} {‖ Φ {\hat{p}}_{k} - Δ {{l}^{̑}}_{k} ‖}_{2}^{2} \\ for \\ k = 1 , … , K \qquad Equation 25$$

Then the uncertainty-based weighing may be applied to obtain the solution:

$${p}^{̑} = \frac{{\sum }_{k = 1}^{K} \frac{1}{{σ}_{k}^{2}} {\hat{p}}_{k}}{{\sum }_{k = 1}^{K} \frac{1}{{σ}_{k}^{2}}} \qquad Equation 26$$

characterizing the wavelength-averaged drift of the OPM over time.

If the maximum deviation of the central wavelength of the laser signal used for the OPM drift compensation is negligible with respect to the assumed maximum error of wavelength measurements performed by the OPM, then the time drift of the OPM may be corrected on the basis of a single result of measurement.

As well, if the standard deviation of the central wavelength averaged over a time interval ΔT is negligible with respect to the assumed standard deviation of the error of wavelength measurements performed by the OPM, and the OPM drift during the time interval ΔT is negligible, then the time drift of OPM may be corrected on the basis of the average of results of measurement performed during ΔT.

Although the present invention has been described by way of a particular embodiment and examples thereof, it should be noted that it will be apparent to persons skilled in the art that modifications may be applied to the present particular embodiment without departing from the scope of the present invention.

I claim:

1. A method for stabilizing a spectrometric transducer for an optical spectrum measurement instrument, comprising:
obtaining an instantaneous central wavelength of a thermally controlled tunable filter of the instrument;
calibrating for a selected ambient temperature;
determining a heat variance of the filter; and
controlling the filter to compensate for the heat variance.
